(19) United States
(12) Patent Application Publication
(10) Pub. No.: US 2022/0415213 A1
(43) Pub. Date: Dec. 29, 2022

(54) ARABIC NUMERAL LABEL

(71) Applicant: PRONOTI INTERNATIONAL INC., Taipei (TW)

(72) Inventor: CHAR-TER JOUR, Taipei (TW)

(21) Appl. No.: 17/356,516

(22) Filed: Jun. 24, 2021

(51) Int. Cl. G09F 3/02; G09F 3/18

(52) U.S. Cl. CPC G09F 3/02; G09F 3/18; G09F 2003/023

(57) ABSTRACT

The present invention discloses an Arabic numeral label, with its label main body made of plastic films. One surface of the label main body is configured with a pattern and an Arabic numeral, and the opposite surface is partially applied with an adhesive. Based on such a structure, in implementation, the Arabic numerals on the surface of the label main body can indicate priority or sequence to enhance efficiency in reading, understanding and signing the documents. Furthermore, the Arabic numeral label is stacked in an alternate arrangement to form a label set for continuous extraction. In addition, the label set can combine a case body. The case body has a plurality of containing troughs and openings. A section of the topmost sheet is exposed when each label set is placed into the containing troughs. Or, through combination of a receiver, more than one case body and more than one label set can be contained for continuous extraction and convenient usage to mark a large quantity of documents.

### BACKGROUND OF INVENTION

### 1. Field of the Invention

The present invention relates generally to a self-adhesive label, and more particularly to an Arabic numeral label having a transparent, translucent or colorful label main body, and having a particular pattern or Arabic numeral on the non-adhesive surface.

### 2. Description of Related Art

Notepad is a typical stationery product. It is made by stacking multiple pieces of paper in a specific shape, with weak adhesive applied partially on the bottom of each piece of paper on the same side, and with a piece of release paper configured on the bottom of the whole stack. Based on such a design, it is very convenient for a user to write a note and stick it on the document or on any surface as a reminder. These paper notepads usually have different colors for users to classify or identify multiple documents. However, as these notepads are made of paper, they are not waterproof, not durable, and may easily get contaminated. Also, due to the adoption of a weak adhesive, the adhesion is not stable and the note may fall off and get lost due to environment or climate factors.

Plastic notepads are also available on the market. They have the same structure as said paper notepads. The only difference is in the material used. They are usually shaped in a simple design like a strip, or in a rectangular or square shape. Although they are more durable than said paper material, they can be mainly used for classification and identification because it is difficult to write something on the plastic surface. Therefore, there is still a need for improvement.

In view of this, to enhance and improve the function of notepads, the inventor developed a technical solution to provide an innovative Arabic numeral label, which makes a breakthrough and overcomes the functional drawbacks of the conventional notepads. The new invention will hopefully benefit the consumers.

### SUMMARY OF THE INVENTION

The primary objective of the invention is to provide an Arabic numeral label with Arabic numerals configured specifically on the surface of the label main body for priority or sequence indication, and to enhance efficiency in reading, understanding and signing the documents.

Another objective of the invention is to provide an Arabic numeral label to facilitate continuous labeling for large amounts of documents by integrating a plurality of label sets using a matching case body with receivers.

To fulfill the above objectives, the present invention provides an Arabic numeral label with the label main body made of plastic films, and with a pattern or an Arabic numeral configured on one surface of the label main body, and an adhesive partially applied on the other surface.

In one embodiment, said label main body can be transparent, translucent or colorful.

In one embodiment, said numeral labels are combined in the form of a stack, and the adhesive is applied on alternating sides piece by piece to form a label set.

In one embodiment, said pattern can any graphic design, including company slogans, logos, trademarks etc.

In one embodiment, said Arabic numerals can also be replaced by Chinese or Roman numbers.

In one embodiment, said Arabic numeral label is further combined with a case body, said case body having: a face shell and a base plate; the holding space of said face shell is partitioned into a plurality of containing troughs, each containing trough has an opening on its bottom, and relative lugs are configured on the periphery of the openings of the holding space; said base plate is a flat plate, to cover and close the opening of the holding space of the face shell, and an arc notch is formed at an appropriate position on one side of the peripheral edge.

In one embodiment, a receiver is further assembled, said receiver including: more than one first groove to hold the case body, and more than one second groove to hold the label sets.

The structural composition, technical means, and functions of the invention will be further detailed below with respect to example embodiments and with reference to accompanying figures:

### BRIEF DESCRIPTION OF THE DRAWINGS

FIG. 1 is a structural view of the Arabic numeral label according to a preferred embodiment of the invention.

FIG. 2 is a sectional view of the label set according to a preferred embodiment of the invention.

FIG. 3 is a usage view of the label set according to a preferred embodiment of the invention.

FIG. 4 is an exploded view of the label set and case body according to a preferred embodiment of the invention.

FIG. 5 is a combined view of the label set and case body according to a preferred embodiment of the invention.

FIG. 6 is a usage view of the label set and case body according to a preferred embodiment of the invention.

FIG. 7 is an exploded view of the label set, case body and receiver according to another preferred embodiment of the invention.

FIG. 8 is a combined view of the label set, case body and receiver according to another preferred embodiment of the invention.

### DETAILED DESCRIPTION OF THE INVENTION

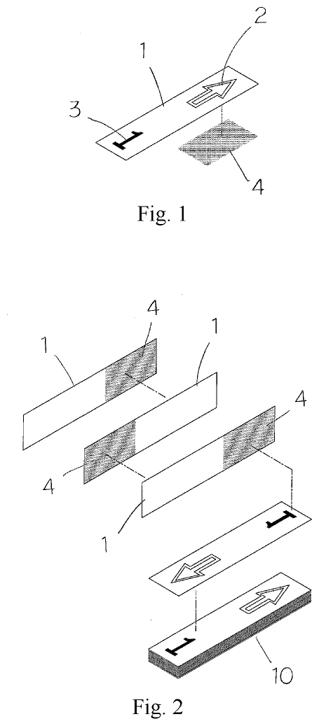

Referring to FIG. 1, the innovative Arabic numeral label disclosed in the invention has a label main body (1) made of transparent, translucent or opaque plastic films. In the present embodiment, it is in the form of strips, but its shape is not limited to this. One surface of the label main body (1) is configured with a pattern (2) and an Arabic numeral (3), and the opposite surface is partially applied with an adhesive (4). The pattern (2) can be any graphic design, including company slogans, logos, trademarks etc. In the present embodiment, it is presented as a simple and sharp arrow; The Arabic numerals (3) can be any numerals, with no limitation to their types, including Chinese or Roman numerals.

Referring to FIG. 2, a plurality of alternately arranged label main bodies (1) are combined to form a stack, with adhesive (4) partially applied on alternating sides piece by piece, forming a label set (10) enabling continuous extraction of one piece at a time; the main purpose of the alternating arrangement is to enable extraction of the label main body (1) always from the side with the numeral (3), without disrupting the order.

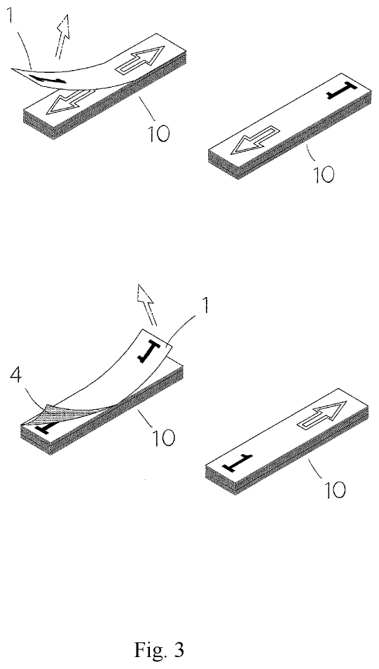

Referring to FIG. 3, to use said continuous extraction label, the upmost label main body (1) is pulled first, and the next label main body (1) beneath it will be brought out due to the adhesion force of the adhesive (4). In this way, the user can continuously pull out the upmost label main body (1).

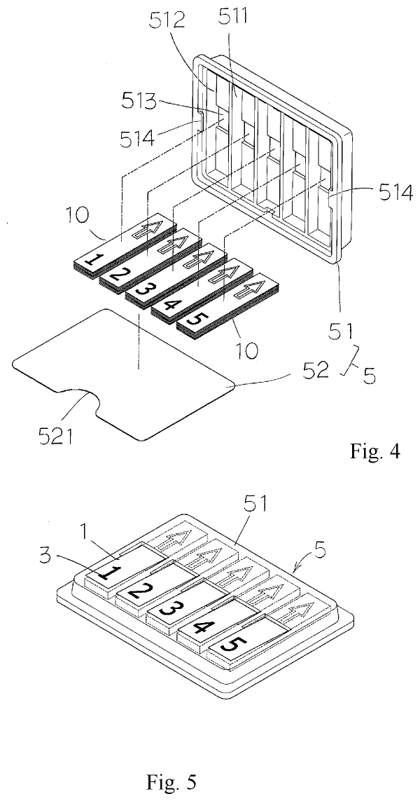

Referring to FIG. 4 and FIG. 5 together, a plurality of label sets (10) are assembled with a case body (5), so that more quantities of label main bodies (1) are available for the user to use. The detailed structure of the case body (5) includes: a face shell (51) and a base plate (52). Said face shell (51) has a protruded holding space, and more than one separating plate (511) is configured with equal intervals, to separate the holding space into a plurality of small containing troughs (512), sized perfectly to embed a label set (10). The plurality of containing troughs (512) can be embedded with multiple label sets (10). Moreover, an opening (513) is provided at an appropriate position on the bottom of each containing trough (512), so that the free end of the upmost label main body (1) of the label set (10) can extend out for the user to pull; furthermore, relative lugs (514) are configured on the periphery of the opening of the holding space; the base plate (52) is a flat plate, used to cover and close the opening of the holding space of the face shell (51). Its size shall be appropriate to fully cover and close the holding space. An arc notch (521) is formed on one side of its periphery edge. Based on such a design, when the base plate (52) is fitted into the holding space, the relative lugs (514) can prevent it from falling apart, so as to avoid accidental drop of the label set (10). As the base plate (52) is made of soft plastics, when it is needed to open the base plate (52) to replenish the label sets (10), the user can just use a finger to pull out the base plate (52) from the arc notch (521), and the label sets can be replenished. The assembly and disassembly is very easy and convenient.

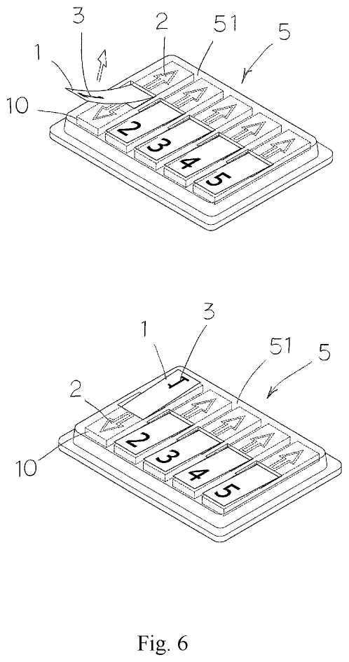

Referring to FIG. 6, to use the assembly of the case body (5) and label set (10), the user can use his/her fingers to clamp the free end of the label main body (1) held in the case body (5), pull it out with a gentle force, and stick it to a document for indication. Every time the user pulls out a label main body (1), the next label main body (1) will be naturally brought out for the next extraction; Because one surface of the label main body (1) has a pattern (2) and an Arabic numeral (3), in general use, the user can use the (arrow) pattern (2) as a guiding sign or indicator. When the label main body (1) is attached to a document, the user can have a clear and immediate understanding; in particular, when the labels are used to indicate the priority of or the order of reading multiple documents, the Arabic numerals (3) on the label main body (1) can immediately let the user know the level of importance or the order of reading multiple documents, so as to avoid confusion or inconsistence of reading.

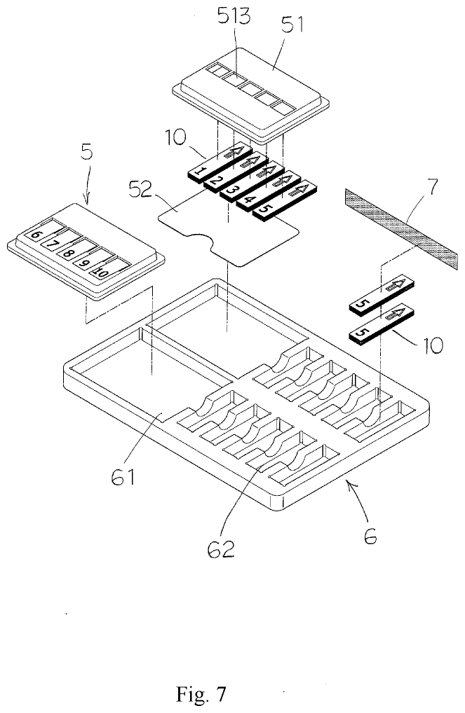

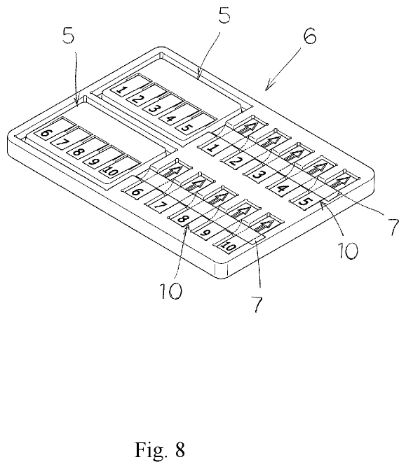

Further referring to FIGS. 7 and 8 together, a receiver (6) with more functions is provided. Said receiver (6) is designed with concave spaces with different shapes and sizes, including: a first groove (61) to hold said case body (5) and a second groove (62) to hold said label sets (10). Multiple first grooves (61) and second grooves (62) can be arranged as needed. As the shapes and sizes of the receivers (6) are not limited, there can be more than one first groove (61) and more than one second groove (62) at the same time. In the present embodiment, the receiver (6) is arranged and partitioned to have two first grooves (61) and ten second grooves (62); each first groove (61) can hold one case body (5), and the case body (5) contains label sets (10) whose Arabic numerals (3) are marked 1-5 and label sets (10) whose Arabic numerals (3) are marked 6-10. In each second groove (62), more than one set of label sets (10) having Arabic numerals (3) marked 1-10 are placed; In this way, the structure offers a combination of multiple case bodies (5) and label sets (10) for immediate use, and multiple independent label sets (10) marked with Arabic numerals (3) from 1 to 10 for replenishment. Moreover, in order to avoid drop of the label sets (10) for replenishment, in implementation, a tape (7) will be attached to stretch across all of the second grooves (62).

As indicated by the above embodiments, the Arabic numeral label of the present invention has the following features: firstly, it is made of plastic films instead of paper to have better durability to avoid damage and loss of the marking function due to environment or climate changes; secondly, the pattern on the label can express a specific meaning, for example, for general documents, an arrow can provide instant and best guidance and indication; last but not least, the Arabic numerals on the label provide indications of priority or sequence, and can enhance efficiency in reading, understanding and signing the documents.

To summarize, the present invention provides numeral labels for indications of priority or sequence. Generally, they can be used for marking and classifying documents. Meanwhile, the patterns like the arrows can provide a distinctive indication. The configuration of the numerals is particularly useful in classifying documents and marking the level of importance or the sequence of reading. The invention can greatly enhance efficiency and is truly an excellent innovation with great practical value for industrialization. Therefore, an application for patent is filed.

Although the invention has been explained in relation to its preferred embodiment, it is to be understood that many other possible modifications and variations can be made without departing from the spirit and scope of the invention as hereinafter claimed.

1. An Arabic numeral label, having a label main body made of plastic films, one surface of said label main body is configured with a pattern and an Arabic numeral, and the opposite surface is partially applied with an adhesive.

2. The Arabic numeral label defined in claim 1, wherein said Arabic numeral label is in the form of stacked sheets in alternating arrangement, and the adhesive is applied on alternating sides to form a label set.

3. The Arabic numeral label defined in claim 1, wherein said pattern can be any graphic design, including company slogans, logos, trademarks etc.

4. The Arabic numeral label defined in claim 1, wherein said Arabic numerals can be any of Chinese numerals or Roman numerals.

5. The Arabic numeral label defined in claim 2, wherein said label set is further combined with a case body, said case body having a face shell and a base plate; the holding space of said face shell is partitioned into a plurality of containing troughs, each containing trough has an opening on its bottom, and relative lugs are configured on the periphery of the openings of the holding space; said base plate is a flat plate, to cover and close the opening of the holding space of the face shell, and an arc notch is formed at an appropriate position on one side of the peripheral edge.

6. The Arabic numeral label defined in claim 5, wherein a receiver is further assembled, said receiver including: more than one first groove to hold the case body, and more than one second groove to hold the label sets.
